(19) United States
(12) Patent Application Publication
(10) Pub. No.: US 2021/0243964 A1
(43) Pub. Date: Aug. 12, 2021

(54) AGRICULTURAL HYBRID PAPER AND METHODS OF MAKING THE SAME

(71) Applicant: Twin Rivers Paper Company LLC, Madawaska, ME (US)

(72) Inventors: BRIAN MCALARY, Madawaska, ME (US); JOSEPH REFF, Little Falls, NY (US); BRENT BREWER, Whitby (CA); DAVID ROCKWOOD, Little Falls, NY (US)

(21) Appl. No.: 17/256,115

(22) PCT Filed: Aug. 6, 2019
(86) PCT No.: PCT/US19/45377

§ 371 Date: Dec. 24, 2020

Related U.S. Application Data
(60) Provisional application No. 62/714,871, filed on Aug. 6, 2018.

(51) Int. Cl. A01G 13/02; A01C 1/04; A01C 15/00; D21H 27/00; D21H 21/20; D21H 21/12; C05G 5/30

(52) U.S. Cl. CPC A01G 13/0268; A01C 1/044; A01C 15/00; A01G 2013/006; D21H 21/20; D21H 21/12; C05G 5/30; D21H 27/00

(57) ABSTRACT

An agricultural paper mulch sheet including a paper based substrate and a nutrient additive. The nutrient additive may be a water soluble nitrogen fertilizer. The agricultural paper may be deployed from rolls and draped over crops in a garden or field, wherein the agricultural paper covers a substantial portion of the soil in which the plants will grow or are growing, while, in some preferred embodiments, providing openings (i.e., holes) for individual plants to emanate from the soil through the agricultural paper set forth around the plant. The sheet is preferably porous, tillable, and biodegradable. The substrate may have an ink pattern printed on it. The method includes applying the nutrient additive to the substrate preferably via a printing process.

### FIELD OF THE INVENTION

The present invention generally relates to paper products for use in agriculture. More specifically, the present invention relates to an agricultural paper product that comprises nutrients printed on the paper.

### BACKGROUND OF THE INVENTION

The prior art discloses various materials, including LDPE films, UV biodegradable films, fabric bed liners to reduce weed growth, and heavy paper mulches that are deployed in various agricultural contexts, including for plant and crop growth in gardens and fields. Such agricultural materials of the prior art are not sustainable for a variety of reasons. For example, some of the weed barriers and bed liners of the prior art are comprised of plastics or fabrics that are neither biodegradable nor recyclable (i.e., the materials cannot be tilled into the soil or salvaged or repurposed). On a commercial farming scale, such materials require intensive labor costs for deployment of the materials in fields, as well as removal of the materials after the growing season. Moreover, once the materials are removed, as noted above such materials cannot be recycled, and in many cases the materials cannot be disposed of in landfills. Therefore, such agricultural materials pose many difficulties, whether for users on a residential scale (i.e., a home garden) or commercial scale (i.e., commercial farmers), ranging from disposal problems to high labor costs associated with use of the materials. Moreover, such products are bad for the environment.

Therefore, there exists a heretofore unmet need in the art for an agricultural material that resolves the aforementioned problems.

### SUMMARY OF THE DISCLOSURE

The present invention is an agricultural paper product that is biodegradable, lightweight, durable, the paper preferably having nutrients and/or other substrates printed thereon. The product preferably breaks down after 90 to 120 days such that the product may be, for example, tilled into the soil on which it is installed. Shorter and longer breakdown durations are contemplated and such may be achieved, for example, through amendments to a wet strength component of the product or other constituent elements thereof. The paper product is preferably porous and tillable. The agricultural paper may be deployed from rolls and draped over crops in a garden or field, wherein the agricultural paper is covers a substantial portion of the soil in which the plants will grow or are growing, while, in some preferred embodiments, providing openings (i.e., holes) for individual plants to emanate from the soil through the agricultural paper set forth around the plant.

Other preferred embodiments may not include the engineered openings through which plants may emanate when the product is first deployed in situ, but the eventual breakdown of the product in the soil will provide the space for target plants to grow. In some embodiments, a portion of the paper may degrade prior to other portions, such that plants may grow through certain portions of the paper while other portions on the paper remain intact protect the plants from weed growth, provide a moisture barrier, a heat barrier, and/or provide nutrients, etc., while the product will later become more tillable on the whole. Preferred embodiments of the paper product may allow different wavelengths of light, such as ultraviolet A, ultraviolet B, and infrared light to be blocked or penetrate the paper. The paper may be configured to accommodate the preferred transmission of or opacity of different wavelengths of light to accommodate different target plants while prohibiting growth of undesirable plants.

One embodiment of the present disclosure is a device for use in the growth of a plant, the device comprising:

a substrate comprising a paper fiber, a wet strength additive, and a defoamer; the substrate having first and second surfaces; and

an aqueous nutrient applied to the substrate;

wherein the paper fiber comprises greater than 90% by weight of the substrate;

wherein the nutrient is applied to at least one of the first and second surfaces of the substrate by printing;

wherein the device has a thickness that is between 2 and 6 mils; and

wherein the device is porous, water permeable, and air permeable.

The present invention may be an Organic Materials Review Institute (“OMRI”) listed 100 percent organic paper fertilizer material having weed prevention properties for up to preferably 90 days, as well as moisture conservation properties, biodegradability, and soil feed quality product made with recycled materials and approved for use with organic food production.

Another embodiment of the present disclosure is a method of manufacturing an agricultural mulch paper, the method comprising:

combining a paper fiber and wet strength additive to form a substrate;

applying one or more nutrients to a surface of the substrate by way of printing; and

drying the substrate after application of the one or more nutrients;

wherein the paper fiber comprises greater than 90% by weight of the substrate;

wherein the device has a thickness that is between 2 and 6 mils; and

wherein the device is porous, water permeable, and air permeable.

Examples of the more important features of the disclosure have been summarized rather broadly in order that the detailed description thereof that follows may be better understood and in order that the contributions they represent to the art may be appreciated. There are, of course, additional features of the disclosure that will be described hereinafter and which will form the subject of the claims appended hereto.

### BRIEF DESCRIPTION OF THE DRAWINGS

The organization and manner of the structure and operation of the invention, together with further objects and advantages thereof, may best be understood by reference to the following description taken in connection with the accompanying drawings wherein like reference numerals identify like elements in which:

FIG. 1A is a top view of an agricultural paper according to one embodiment of the present disclosure.

FIG. 1B is a top view of the agriculture paper of FIG. 1A deployed in situ.

FIG. 1C is a three-dimensional view of the FIG. 1B.

FIG. 2 is a flow chart of a method of manufacturing the agricultural paper according to one embodiment of the present disclosure.

### DETAILED DESCRIPTION OF THE DISCLOSURE

While this invention may be susceptible to embodiment in different forms, there are shown in the drawings and will be described herein in detail, specific embodiments with the understanding that the present disclosure is to be considered an exemplification of the principles of the invention, and is not intended to limit the invention to that as illustrated.

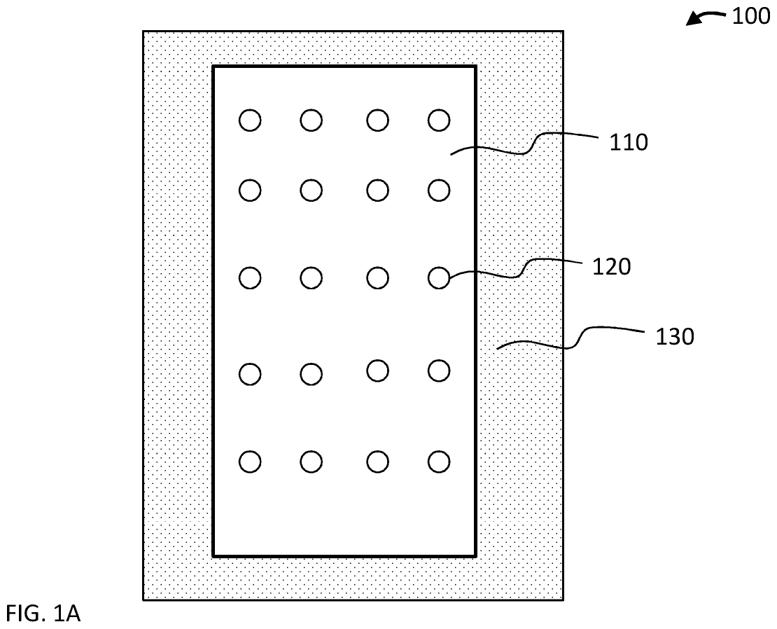

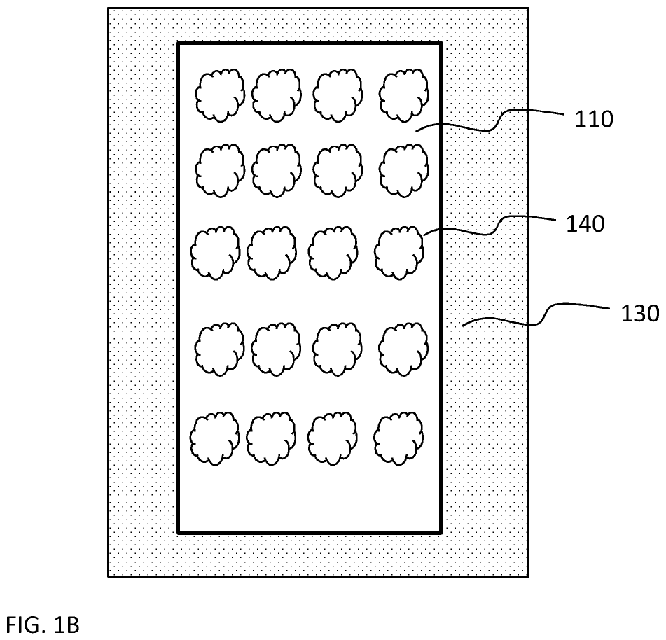

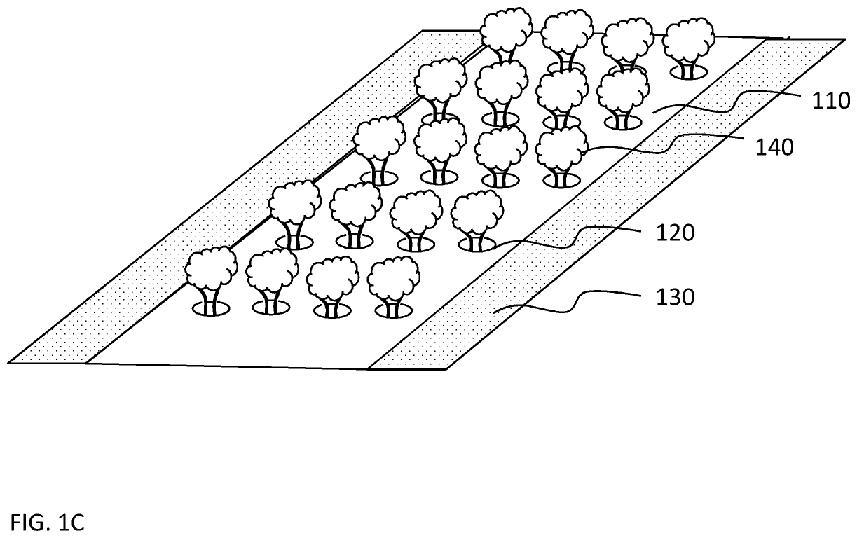

FIG. 1A shows a top view of an agricultural paper sheet 100. The sheet 100 may include a paper based substrate 110 and one or more openings 120 to allow crops/desired plants to grow from soil 130 through the substrate 110. The substrate 110 may be printed, coated, or impregnated with nutrients beneficial to crop growth. The substrate 110 may be coated/impregnated/printed with nutrients before or after the openings 120 are formed in the paper 100. Some preferred embodiments may not include the engineered openings through which plants may emanate when the product is first deployed in situ, but the eventual breakdown of the product in the soil will provide the space for target plants to grow. The nutrients may include substances that promote the growth of crops 130, such as plant-based water soluble nitrogen fertilizers, including straight fertilizers, auxiliary substances (such as those improving plant nutrition by editing environmental factors or affecting the metabolism of plants) mineral fertilizers, manure fertilizers, solid fertilizers, aqueous fertilizers, single-component fertilizers, and multi-component fertilizers. One exemplary and non-limiting nutrient is Purely 14-0-0 WSN, manufactured and sold by Purely Organic Products, LLC of Portsmouth, N.H. In some embodiments, the substrate may also be coated or impregnated with chemicals to inhibit growth of or kill weeds. In other preferred embodiments, the substrate may also be coated, impregnated, or printed with seed, fungicide, disease control elements, or pesticides. It is contemplated that combinations of substances may be coated/impregnated/printed on the substrate to achieve a particular use and function of the product.

FIG. 1B shows a top view of the agricultural mulch paper sheet 100 deployed over the soil 130 with crops 140 emerging from the openings 120. FIG. 1C shows a three-dimensional view of FIG. 1B. The substrate 110 may include a number of materials. In some embodiments, the substrate 110 may include unbleached northern softwood, hardwood, and/or recycled fiber. Fibers may include natural fibers, such as cotton, linen, wool, and silk. Fibers may include natural polymers such as rayon, cellulose acetate, and triacetate. Fibers may include synthetic fibers such as nylon, polyester, acrylic, olefin, vinyl, elastanes, glass, and aramid fibers.

In some embodiments, the substrate 110 may include a wet strength additive to increase the strength of the substrate 110 during and after deployment. Suitable wet strength additives include, but are not limited to polyamide-epichlorohydrin (PAE) wet strength resin. Temporary wet strength agents, neutral sizing agents such as alkenylsuccinic anhydride (ASA) or alkylketene dimer (AKD) chemistries may be used. Urea formaldehyde and melamine formaldehyde may be used, but are not preferred, as wet strength resins since these compounds are not as environmentally friendly as other wet strength resins formed from renewable resources.

In some embodiments, the substrate 110 may include a defoaming compound, including but not limited to aqueous defoamers, insoluble oils, polydimethylsiloxanes and other silicones, certain alcohols, stearates, and glycols. In some embodiments, the softwood portion of the substrate 110 may be 100%. In other embodiments, the substrate may be 50% softwood and 50% hardwood. In other embodiments, the substrate may comprise 90% to 100% recycled fiber, and preferably 96% recycled fiber, and more preferably 99% recycled fiber. The wet strength additive may be in a range of 4 to 15 dry pounds per ton of fiber or wood in the substrate, and more preferably 9-10 dry pounds per ton of fiber or wood in the substrate. The defoamer may be in a range of 0 to 1 pound per ton of fiber in the substrate, and preferably 0.5 pounds per ton of fiber in the substrate. In some embodiments, substrate 110 may be composed of, by weight, approximately 99.93 percent softwood, approximately 0.044 percent wet strength additive, and approximately 0.026 percent defoamer.

The paper 100 may be lightweight and thin compared to paper mulch products of the prior art. The paper 100 may be 8 to 35 pounds per 3000 square feet of paper 100, or 16.3 grams per square meter (“GSM”) to 82.5 GSM, and preferably 30 GSM to 57.1 GSM. The thickness of the paper 100 is preferably 2.0 to 6.0 mils, and preferably 4.0 mils. The paper 100 may be durable, having a 90-day minimum in soil contact durability, although the paper 100 may be engineered to provide for variable durations of durability in situ.

The type of paper fibers and wet strength additive can be amended to adjust for durability of the product. For example, since softwood is more durable than hardwood, less wet strength additive can be added to softwood compositions as compared to hardwood ones. Wet strength concentration and/or addition rates also affect durability. Recycled fibers typically fall somewhere in the middle of softwood and hardwood applications with respect to natural durability to be amended in formation of the paper 100. Additionally, the thickness or weight of the paper 100 can be amended to adjust durability and breakdown of the product. Typically higher weight paper will have more natural strength in resisting breakdown.

The paper 100 and substrate 110 are biodegradable, such that embodiments may be tilled into the soil 130 after use (i.e., after harvesting of the crops 140 and completion of the growing season) for biodegradation of the paper 100. In some embodiments, the wet strength additive may aid the paper 100 in sustaining the ability to be effectively tilled directly into the soil 140 after use.

The paper 100 is configured to conform with the contours and textures of the soil 140 over which the paper is draped. Additionally, because the paper 100 is lightweight and has an engineered elasticity, it can be draped over fragile plants, such as roses, while mitigating the risk of damage to such crops 130.

The substrate 110 may be configured to control porosity and controlling of pore size by balancing pulp refining, drainage protocols on the fourdriner of the paper machine, and creping procedures with a creping blade in type of material and angle, such that water is allowed to flow through the paper 100 and into the soil 140. In some embodiments, the paper 100 is also air permeable.

Increased refining usually results in a denser, less porous sheet 100. However; different fibers used and the mix of fibers used can help improve the permeability of paper 100 as well. You can expect there to be a fairly strong correlation between water-permeability during formation and air-permeability of the final sheet 100. Additionally, controlling the jet speed from a headbox with the speed of forming fabric or wire can help improve the formation and the fiber bonding on a paper machine. A uniform surface of paper 100 created through calendaring is likely to improve air and water permeability, since air is expected to move preferentially through the thin areas if the caliber of the paper 100 is not consistent. This kind of problem ought to be readily apparent if one holds paper up to the light. The use of retention aids in the paper 100 making process will also help. Solutions can include either reducing the dosage of retention aid treatment or moving the addition point to the upstream side of a pressure screen.

Practical mechanical measures to decrease air-permeability include: (a) increased refining; (b) increased wet-press loading; (c) increased calendaring; (d) reduced internal sizing to allow more uptake of size-press starch; and (d) increased size-press starch viscosity to achieve a better film. Some of the most promising ways to decrease air-permeability through paper 100 involve surface applications. To maximize the effect of size-press starch, with respect to sealing the paper 100, it makes sense to take measures that tend to hold the starch out at the paper 100 surface. Such measures include internal sizing, increasing the solids content or viscosity of the starch solution, and the use of film-applicator types of size press. In addition, one can add certain copolymers to the formulation. Sodium alginate (from seaweed), polyvinyl alcohol, styrenemaleicanhydride (SMA), and similar copolymers are often found to decrease the air-permeability of paper 100 to a greater degree than starch alone. Delaminated clay added at the size press can be expected to make the paper less permeable, though the use of minerals at the size press depends on having suitable equipment and procedures.

In some embodiments, the substrate 110 may be selected from or prepared with a material that filters out selected wavelengths of light. This allows the transmission of light wavelengths that are beneficial to the crops 130 while blocking the transmission of some wavelengths that are either detrimental to the crops 130 or beneficial to the growth of weeds. In some embodiments, the substrate 110 blocks a significant amount of ultraviolet radiation, which serves to inhibit weed growth, while also allowing for transmission of infrared radiation to the soil, which warms the soil and promotes growth of the crops 130. The transmission of infrared radiation is commonly a function of the pulp species used in the substrate 110. Variable, thicker paper 100 traps more heat, and the topography of the paper 100 may be amended to form an insulator such as a laminate air pocket or embossed male and female air pockets that provide thermal insulation. The substrate 110 can be amended to transmit or block certain wavelengths of UV-A and/or UV-B. The opacity of the substrate 110 can affect light transmission and blocking, and natural lignin in unbleached paper absorbs UV light. In some embodiments, a color may be printed onto the paper to allow certain wavelengths of visible light through the substrate 110, exclusive of or in addition to UV-A and UV-B absorbency, to accommodate the specific optimal growth requirements of target plants.

In some embodiments, sheet 100 may optionally include printed colors or patterns (i.e., for branding and the like) applied to the substrate 110. The colors or patterns may be applied to enhance growth of the crops.

In some embodiments, the nutrient may be printed onto the substrate 110, or provided by extrusion coating. In some embodiments, printing of colors or patterns can occur concurrently with the printing of nutrients, or during separate step prior to or after nutrient printing/deposition. In some embodiments of the substrate 110, the nutrients are place in solution and printed on one side of the paper, while the print branding may be printed on the other side of the paper, most often wherein the nutrients face the soil and the branding faces away from the soil so it can be noticed. Color may also be added to the nutrients when they are printed and formed into branding patterns.

Preferred colors or color patterns include: (i) black, which is economical and provides weed control, and warms soil; (ii) white, which is the coolest of all colors; (iii) white over black, which is cooler than black, but prevents more weed growth than just white; (iv) silver over black, which reduces insect populations and inhibits weed growth; (v) clear, which solarizes soil killing soil-borne diseases without fumigants; and (vi) red, which increases yield in certain vegetables.

Some embodiments of the present disclosure comprise nutrients that are printed onto the agricultural paper sheet 100. They could be printed as a pattern by changing the gravure (cylinder) of anilox roll on the paper making equipment. Such nutrients may vary, but by and large they are intended to assist with fertilization of plants and crops intended to benefit from the agricultural paper. The paper 100 may comprise weed control materials, but principally it is intended to fertilize plants while the paper itself naturally mitigates weed growth without harmful chemicals.

The substrate 110 may be combined with other materials, such as biopolymer film.

The production advantages of the agricultural paper sheet 100 over the prior art include, but are not limited to:
a. Earlier planting dates for crops;
b. Soil moisture retention;
c. Weed management;
d. Reduction in the leaching of fertilizers;
e. Improved crop quality;
f. Reduction in soil compaction;
g. Reduction in root damage;
h. Higher yields;
i. End of life solution: soil biodegradation of 6 months to 2 years—paper gauge, soil type, and microbial activity influence biodegradation rate.

The substrate 110 may be provided in varying packaging and roll configurations and sizes.

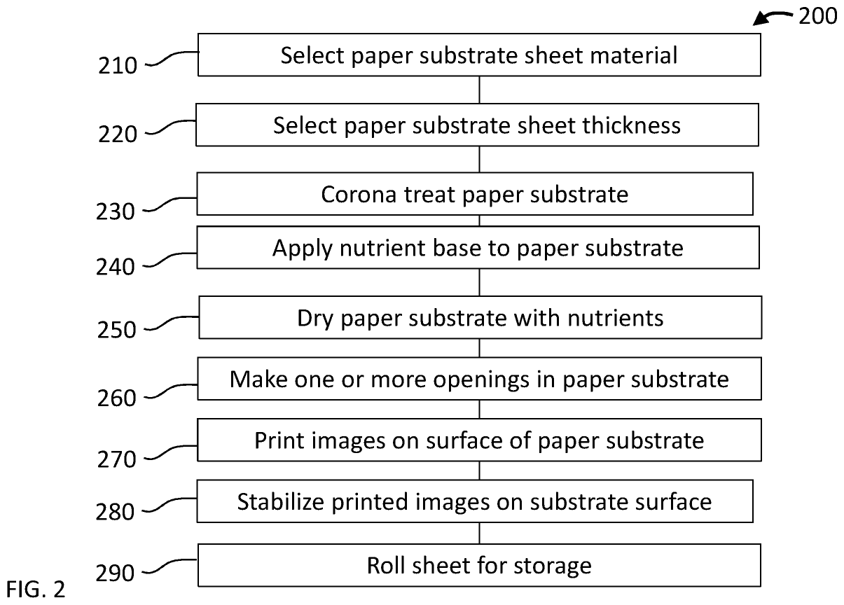

FIG. 2 shows a flow chart of one embodiment of a method 200 of preparing the agricultural mulch paper 100. In step 210, the material for the substrate 110 is selected. In some embodiments, the material is a softwood. In some embodiments, the material is an unbleached northern softwood. In some embodiments the material uses recycled fiber. In step 220, the thickness of the substrate is selected. The thickness may be selected in a range of about 4.5 mils to about 5.8 mils. In some embodiments, the thickness may be selected such that the substrate 110 will block ultraviolet light. In some embodiments, the thickness will be a function of paper 100 weight, which may range from 8 to 15 pounds (30 to 82.5 grams per square meter). Other suitable paper thicknesses are contemplated. In step 230, the substrate 110 may be corona treated. Herein, corona treating means applying an electrical charge to the paper fibers of the substrate 110 so that the fibers are heated and oriented on the face of the substrate prior to receiving added nutrients. In step 240, one or more nutrients are applied to the substrate 110. Application of the nutrients may include one or more of applying a coating to the surface of the substrate 110, printing on the surface of the substrate. The printing of the substrate 110 provides efficiency in the use of raw materials, customized pattern capabilities and improved speeds in manufacturing, converting and impregnating the substrate 110. In some embodiments, the nutrients may be applied via an aqueous suspension that is printed onto the surface of the substrate 110. In some embodiments, the aqueous suspension is temperature controlled to protect against chemical reactions or alteration of the nutrients within the aqueous suspension. In some embodiments, the aqueous suspension is applied to the substrate 110 at a temperature of about 40 degrees Celsius. Other suitable temperature applications are contemplated. In step 250, the substrate 110 may be dried after the application of the nutrients. Drying may involve heating and/or blowing dry air over the substrate 110. In step 260, one or more openings 120 may be made in the substrate 110. The openings 120 may be distributed along substrate 110 to form a pattern desirable for the organization and spacing of crops 130. In some embodiments, step 260 may be performed out of order. In step 270, images may be printed on the surface of the substrate 110. The printing may include application of organic ink. The images or patterns that are printed may provide coloration, instruction, or light filtering. In step 280, the printed images are stabilized. In some embodiments, stabilizing may include washing with a fixing compound, heating, or drying. In step 290, the sheet 100 is rolled up for storage and sale.

While embodiments in the present disclosure have been described in some detail, according to the preferred embodiments illustrated above, it is not meant to be limiting to modifications such as would be obvious to those skilled in the art.

The foregoing disclosure and description of the disclosure are illustrative and explanatory thereof, and various changes in the details of the illustrated apparatus and system, and the construction and the method of operation may be made without departing from the spirit of the disclosure.

What is claimed is:

1. A device for use in the growth of a plant, the device comprising:
a substrate comprising a paper fiber, a wet strength additive, and a defoamer; the substrate having first and second surfaces; and
an aqueous nutrient applied to the substrate;
wherein the paper fiber comprises greater than 90% by weight of the substrate;
wherein the nutrient is applied to at least one of the first and second surfaces of the substrate by printing;
wherein the device has a thickness that is between 2 and 6 mils; and
wherein the device is porous, water permeable, and air permeable.

2. The apparatus of claim 1, wherein the substrate is made of a wavelength filtering material that reduces the passage of ultraviolet light through the device.

3. The apparatus of claim 1, wherein the substrate is made of a wavelength filtering material that allows the passage of infrared light through the device.

4. The apparatus of claim 1, wherein the device has a weight of between about 16 grams per square meter and 83 grams per square meter.

5. The apparatus of claim 1, further comprising biodegradable ink printed on a surface of the substrate.

6. The apparatus of claim 1, wherein the nutrient comprises a water-soluble nitrogen fertilizer.

7. The apparatus of claim 1, wherein the paper fiber comprises greater than 98% of the substrate, the wet strength additive comprises no greater than 2% of the substrate, and the defoamer comprises no greater than 2% of the substrate.

8. The apparatus of claim 7, wherein the nutrient is selected from the group consisting of a water-soluble nitrogen fertilizer, seed, or combination of water-soluble nitrogen fertilizer and seed.

9. The apparatus of claim 1, wherein the nutrient is printed on the first surface of the substrate and an ink is printed on the first surface of the substrate.

10. The apparatus of claim 1, wherein the nutrient is printed on the first surface of the substrate and an ink is printed on the second surface of the substrate.

11. The apparatus of claim 1, wherein the device comprises openings through which plants may grow.

12. A method of manufacturing an agricultural mulch paper, the method comprising:
combining a paper fiber and wet strength additive to form a substrate;
applying one or more nutrients to a surface of the substrate by way of printing; and
drying the substrate after application of the one or more nutrients;
wherein the paper fiber comprises greater than 90% by weight of the substrate;
wherein the device has a thickness that is between 2 and 6 mils; and
wherein the device is porous, water permeable, and air permeable.

13. The method of claim 12, further comprising:
applying the one or more nutrients to a first surface of the substrate by way of printing and applying an ink to a second surface of the substrate by way of printing.

14. The method of claim 12, further comprising:
corona treating the substrate before applying the one or more nutrients.

15. The method of claim 12, wherein at least one of the one or more nutrients is a water-soluble nitrogen fertilizer.

16. The method of claim 12, wherein the drying step comprises heating the substrate.

17. The method of claim 12, wherein the paper has a weight of between about 16 grams per square meter and 83 grams per square meter.

18. The method of claim 12, wherein the wherein the paper fiber comprises greater than 98% of the substrate, the wet strength additive comprises no greater than 2% of the substrate, and the defoamer comprises no greater than 2% of the substrate, and the one or more nutrients is selected from the group consisting of a water-soluble nitrogen fertilizer, seed, or combination of water-soluble nitrogen fertilizer and seed.
